(19) United States
(12) Patent Application Publication
(10) Pub. No.: US 2026/0145789 A1
(43) Pub. Date: May 28, 2026

(54) CLUTCH FOR ROTORCRAFT DRIVE SYSTEM

(71) Applicant: Textron Innovations Inc., Providence, RI (US)

(72) Inventors: Nicholas Jones, Fort Worth, TX (US); Eric Olson, Fort Worth, TX (US); Jacob Speed, Cullman, AL (US); Logan Dill, Fort Worth, TX (US)

(21) Appl. No.: 18/962,423

(22) Filed: Nov. 27, 2024

(51) Int. Cl. B64C 29/00; B64D 35/00; F16D 41/07

(52) U.S. Cl. CPC B64C 29/0033; B64D 35/00; F16D 41/07

(57) ABSTRACT

A sprag clutch includes sprags disposed in a retainer, wherein the retainer includes openings arranged around the retainer, wherein the openings are a first distance from a first annular sidewall of the retainer and are the first distance from a second annular sidewall of the retainer opposite the first annular sidewall; and a first cylindrical surface sharing an edge with the first annular sidewall and extending a second distance from the first annular sidewall, wherein the second distance is less than the first distance; a second cylindrical surface sharing an edge with the second annular sidewall and extending the second distance from the second annular sidewall; and a recessed surface between the first cylindrical surface and the second cylindrical surface.

### TECHNICAL FIELD

The present invention relates generally to a sprag clutch and a drive system of a rotorcraft comprising a sprag clutch.

### BACKGROUND

A rotorcraft may include one or more rotor systems including one or more main rotor systems. A main rotor system generates aerodynamic lift to support the weight of the rotorcraft in flight and thrust to move the rotorcraft in forward flight. Another example of a rotorcraft rotor system is a tail rotor system. A tail rotor system may generate thrust in the same direction as the main rotor system's rotation to counter the torque effect created by the main rotor system. For smooth and efficient flight in a rotorcraft, a pilot balances the engine power, main rotor collective thrust, main rotor cyclic thrust and the tail rotor thrust, and a control system may assist the pilot in stabilizing the rotorcraft and reducing pilot workload. The systems for engines, transmissions, drive system, rotors, and the like, are critical to the safe operation of the rotorcraft in flight. The elements of system such as mechanical systems, electrical systems, hydraulic systems, and the like, are each subject to unique wear factors and monitoring, inspection or maintenance requirements.

### SUMMARY

In embodiments of the present disclosure, a rotorcraft clutch includes an inner race; an outer race; and a sprag clutch between the inner race and the outer race. The sprag clutch includes multiple sprags and a retainer. The retainer includes a first rim at a first end of the retainer, wherein the first rim has a first width; a second rim at a second end of the retainer, wherein the second rim has the first width; and an outer surface extending axially from the first rim to the second rim, wherein the outer surface faces an inner surface of the outer race, wherein the outer surface includes a first pilot surface at the first end, a second pilot surface at the second end, and a recessed surface extending from the first pilot surface to the second pilot surface, wherein the first pilot surface extends a second width from the first end, wherein the second pilot surface extends the second width from the second end, wherein the second width is smaller than the first width. In an embodiment, the first pilot surface and the second pilot surface are parallel to the inner surface of the outer race. In an embodiment, a region of the recessed surface has a curved profile. In an embodiment, a region of the recessed surface has a stepped profile. In an embodiment, a region of the recessed surface has a sloped profile. In an embodiment, the recessed surface axially overlaps the first rim and the second rim. In an embodiment, a region of the recessed surface is parallel to the first pilot surface. In an embodiment, the outer surface includes an opening, wherein the first pilot surface is closer to the first end than the opening. Embodiments described herein can allow for reduced wear within a rotorcraft clutch.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A and 1B illustrate a tiltrotor aircraft, in accordance with some embodiments.

FIG. 2 illustrates a sprag clutch, in accordance with some embodiments.

FIG. 3 illustrates a sprag clutch, in accordance with some embodiments.

FIGS. 4A and 4B illustrate a sprag clutch retainer.

FIGS. 5A and 5B illustrate a sprag clutch retainer, in accordance with some embodiments.

FIG. 6 illustrates a sprag clutch retainer, in accordance with some embodiments.

FIGS. 7A and 7B illustrate a sprag clutch retainer, in accordance with some embodiments.

FIGS. 8A, 8B, 8C, 8D, and 8E illustrate sprag clutch retainers, in accordance with some embodiments.

FIG. 9 illustrates a gearbox comprising a sprag clutch, in accordance with some embodiments.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The increasing use of rotorcraft, in particular, for commercial and industrial applications, has led to the development of larger more complex rotorcraft. However, as rotorcraft become larger and more complex, the differences between flying rotorcraft and fixed wing aircraft has become more pronounced. Since rotorcraft use one or more main rotors to simultaneously provide lift, control attitude, control altitude, and provide lateral or positional movement, different flight parameters and controls are tightly coupled to each other, as the aerodynamic characteristics of the main rotors affect each control and movement axis. For example, the flight characteristics of a rotorcraft at cruising speed or high speed may be significantly different than the flight characteristics at hover or at relatively low speeds.

Additionally, different flight control inputs for different axes on the main rotor, such as cyclic inputs or collective inputs, affect other flight controls or flight characteristics of the rotorcraft. For example, pitching the nose of a rotorcraft forward to increase forward speed will generally cause the rotorcraft to lose altitude. In such a situation, the collective may be increased to maintain level flight, but the increase in collective requires increased power at the main rotor which, in turn, requires additional anti-torque force from the tail rotor. This is in contrast to fixed wing systems where the control inputs are less closely tied to each other and flight characteristics in different speed regimes are more closely related to each other.

Some aircraft, such as rotorcraft, have one or more sprag clutches (e.g., freewheeling clutches, overrunning clutches, or the like). A sprag clutch transmits torque in one rotational direction (e.g., the “engaged direction”) but does not transmit torque in the opposite rotational direction (e.g., the “reverse direction”). As an example, a sprag clutch may comprise a rotating inner element and a rotating outer element. When the rotational speed of the inner element is greater than the rotational speed of the outer element, the sprag clutch is in an “overrunning” condition (e.g., a “freewheeling” condition) in which the inner element and outer element rotate independently, and no torque is transferred between the inner element and the outer element. In some cases, when the rotational speed of the outer element is the same as (or greater than) the rotational speed of the inner element, the clutch engages and the inner element and outer element rotate together, as if a single rotating element.

Sprag clutches may have various utilizations within a rotorcraft. As an example, the power generated by an engine of a rotorcraft may be coupled to other components (e.g., a proprotor, an accessory gearbox, etc.) through an overrunning clutch in a gearbox. Under typical operation, sprag clutches connect the engine to the rotor through the rotorcraft's transmission and ensure torque transmission to the hub. Following engine failures, these devices disengage to allow the rotor system to maintain higher rotation speeds than the engine. This allows optimal autorotation performance and does not back drive the engine in the event of engine damage. As another example, an overrunning clutch may couple a starter to an engine to allow the starter to be decoupled once the engine reaches sufficient speed. As another example, the engines of a multi-engine rotorcraft may be coupled by an overrunning clutch to control torque transfer between engines. Sprag clutches also allow single engine startup in a multi-engine rotorcraft without driving the other engine(s). For example, a first engine may be started before a second engine, with the overrunning clutch remaining in an overrunning condition until the rotational speed of the second engine reaches that of the first, at which point the clutch engages and the engines are coupled. As another example, an overrunning clutch may couple the engine(s) to the rotor in order to allow autorotation of the rotor during engine failure. Other example utilizations are possible.

One possible failure mode of a sprag clutch is when the clutch “slips” while under load. During the slip, the sprag clutch stops transmitting torque for a very small time (e.g., “sprag popping”). In this situation, the sprags suddenly rotate out of the engaged position due to loss of frictional contact. This allows the engine power turbine to overspeed as fuel is still being delivered temporarily. The clutch is always trying to re-engage, and will eventually do so. When re-engagement occurs, it occurs abruptly, and the inertia built up in the faster spinning power turbine creates significant torque transients through the drive system. This re-engagement is referred to as a Hard Clutch Engagement (HCE). In some cases, an HCE event induces a torque impulse (e.g., a spike) to the rotorcraft's drive system, which may result in damage to interconnect drive shafts, accessory gearbox drive shafts, or other components. As another example failure mode, out-of-phase sprag engagement occurs when individual sprag elements (e.g., of different rows) engage in dis-similar gripping angle positions. In this condition, sprags are unevenly sharing the load. As torque is increased, the more highly loaded sprags exceed their load carrying capability and suddenly rotate out of engaged position (e.g., sprag popping). One sprag popping can result in a rapidly progressive failure which ultimately results in the “slip” event. In some cases, wear is a contributing factor to clutch slip events. In some cases, polishing of the raceway reduces the friction between the inner race and outer race and increases the possibility of exceeding the load carrying capability of the sprags. Additionally, wear of the retainer of the sprag clutch may contribute to the out-of-phase sprag engagements. Contact between the retainer and the outer race can result in retainer wear, which can cause uneven sprag spacing, clutch slips, or other undesirable conditions. The embodiments described herein can improve performance of a sprag clutch and reduce the risk of HCE, out-of-phase engagement, or other failure modes.

Embodiments presented herein are directed to a sprag clutch having improved efficiency and reliability, and a drive system for a rotorcraft that utilizes the sprag clutch to improve rotorcraft operation and reliability. The sprag clutches described herein have retainers with contoured profiles to reduce contact between the retainer and the outer race during operation at relatively high rotational speeds. The surfaces of the retainers facing the outer race may be contoured to reduce the effects of deflection due to centrifugal force loading during operation, and allow for clearance to be maintained between the retainer and the outer race during operation. Thus, wear on surfaces of the retainer and/or outer race may be reduced or avoided. Embodiments described herein allow for a robust design that reduces the probability of failure modes.

The embodiments herein may be applied to a variety of rotorcraft, such as helicopters, tiltrotor aircraft, manned rotorcraft, unmanned rotorcraft, multi-engine rotorcraft, multi-rotor rotorcraft, or the like. These are examples, and other rotorcraft or rotorcraft systems are possible.

In some embodiments, the rotorcraft may include a Fly-By-Wire (FBW) system to assist pilots in stably flying the rotorcraft and to reduce workload on the pilots. The FBW system may provide different control characteristics or responses for cyclic, pedal or collective control input in the different flight regimes, and may provide stability assistance or enhancement by decoupling physical flight characteristics so that a pilot is relieved from needing to compensate for some flight commands issued to the rotorcraft. FBW systems may be implemented in one or more flight control computers (FCCs) disposed between the pilot controls and flight control systems, providing corrections to flight controls that assist in operating the rotorcraft more efficiently or that put the rotorcraft into a stable flight mode while still allowing the pilot to override the FBW control inputs. The FBW systems in a rotorcraft may, for example, automatically adjust power output by the engine to match a collective control input, apply collective or power correction during a cyclic control input, provide automation of one or more flight control procedures provide for default or suggested control positioning, or the like. The FCCs may provide these functions according to control laws (CLAWS). In some embodiments, multiple FCCs are provided for redundancy. One or more modules within the FCCs may be partially or wholly embodied as software and/or hardware for performing any functionality described herein.

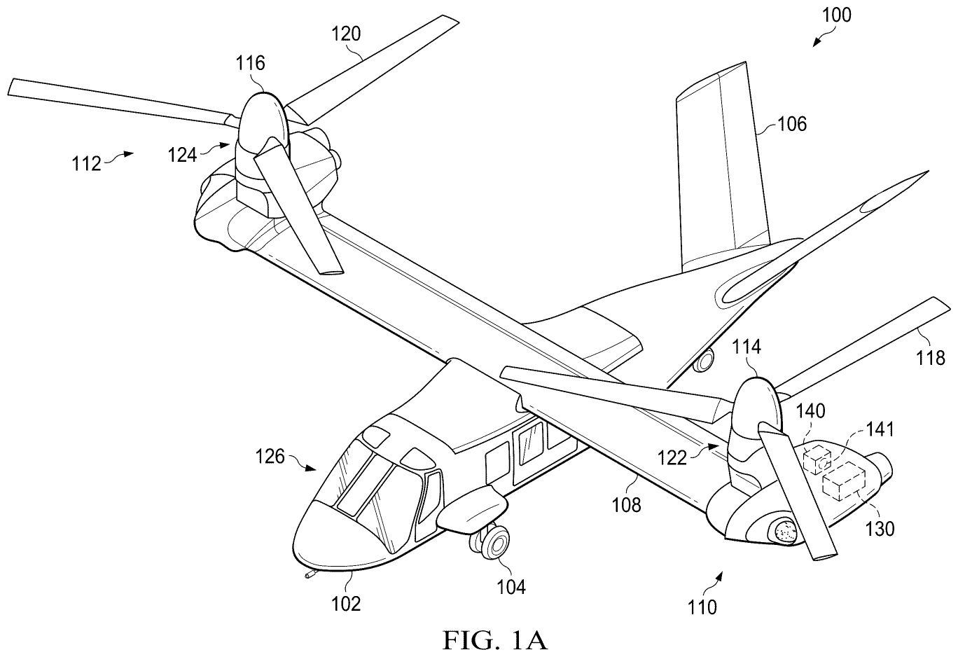

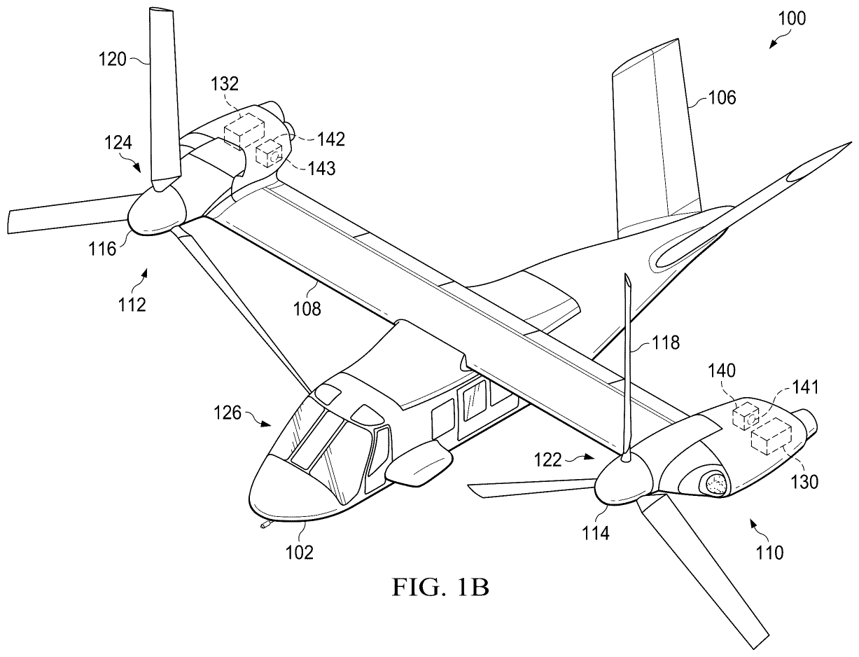

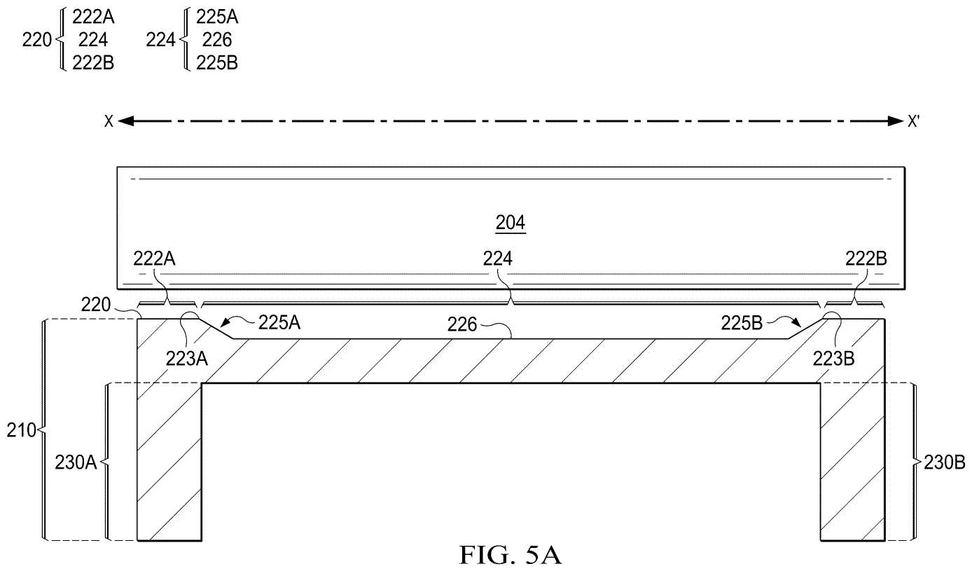

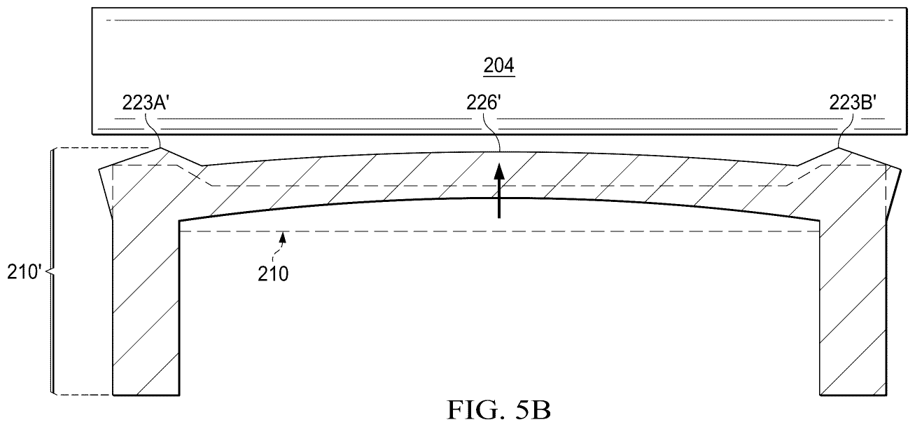

FIGS. 1A and 1B illustrate a tiltrotor aircraft 100 according to some embodiments. Tiltrotor aircraft 100 includes a left rotor system 110 and a right rotor system 112, which are part of the drive system of the tiltrotor aircraft 100. The left rotor system 110 includes a left fixed engine 130 that provides power to a left proprotor 114. The power of the left fixed engine 130 is coupled to the left proprotor 114 through a left gearbox 140. The rotorcraft 101 may comprise other gearboxes coupled to the left gearbox 140. The left gearbox 140 comprises a sprag clutch 141 which may be similar to embodiment sprag clutches described in greater detail below. For example, the sprag clutch 141 may include a retainer (not separately illustrated in FIGS. 1A-1B) that may be similar to the retainers 210 described in greater detail below for FIGS. 5A-8E. In some cases, the left gearbox 140 comprises two or more sprag clutches 141 in a sprag clutch assembly. The left proprotor 114 comprises a plurality of rotor blades, and a single rotor blade 118 is labeled in FIGS. 1A-1B.

The right rotor system 112 includes a right fixed engine 132 (not indicated in FIG. 1A) that provides power to a right proprotor 116 through a right gearbox 142 (not indicated in FIG. 1A). The right gearbox 142 also comprises a sprag clutch 143 which may be similar to embodiment sprag clutches described in greater detail below. For example, the sprag clutch 143 may include a retainer (not separately illustrated in FIGS. 1A-1B) that may be similar to the retainers 210 described in greater detail below for FIGS. 5A-8E. In some cases, the left gearbox 140 comprises two or more sprag clutches 143 in a sprag clutch assembly. The rotorcraft 101 may comprise other gearboxes coupled to the right gearbox 142. The right proprotor comprises a plurality of rotor blades 120, and a single rotor blade 120 is labeled in FIGS. 1A-1B. The fixed engines 130/132 of the left rotor system 110 and the right rotor system 112 may be controlled according to signals from the FBW system. The pitch of the left rotor blades 118 may be controlled by a left swashplate 122, and the pitch of the right rotor blades 120 may be controlled by a right swashplate 124. The left swashplate 122 and the right swashplate 124 selectively control the attitude, altitude, and movement of the tiltrotor aircraft 100. The left and right swashplates 122/124 may be used to collectively or cyclically change the pitch of the rotor blades 118/120 respectively. The position and/or orientation of each swashplate 122/124 is changed by one or more actuators (not shown in FIGS. 1A-1B). In some embodiments, the FBW system sends electrical signals to the swashplate actuators to control flight of tiltrotor aircraft 100.

Rotorcraft 101 further includes a wing 108, landing gear 104, fuselage 102, and tail section 106. Tail section 106 may have other flight control devices such as horizontal or vertical stabilizers, rudder, elevators, or other control or stabilizing surfaces that are used to control or stabilize flight of tiltrotor aircraft 100, which may include differing platform stability considerations depending on the applied configuration. Fuselage 102 includes a cockpit 126, which includes displays, controls, and instruments. It should be appreciated that even though tiltrotor aircraft 100 is depicted as having certain illustrated features, tiltrotor aircraft 100 may have a variety of implementation-specific configurations. For instance, in some embodiments, cockpit 126 may be configured to accommodate a pilot or a pilot and co-pilot. It is also contemplated, however, that tiltrotor aircraft 100 may be operated remotely, in which case cockpit 126 could be configured as a fully functioning cockpit to accommodate a pilot (and possibly a co-pilot as well) to provide for greater flexibility of use, or could be configured with a cockpit having limited functionality (e.g., a cockpit with accommodations for only one person functioning as the pilot, operating perhaps with a remote co-pilot, or as a co-pilot or back-up pilot with primary piloting functions being performed remotely). In yet other contemplated embodiments, tiltrotor aircraft 100 could be configured as an unmanned vehicle, in which case cockpit 126 could be eliminated entirely in order to save space and cost.

FIG. 1A illustrates the tiltrotor aircraft 100 in a grounded helicopter mode, in which proprotors 114 and 116 are positioned (e.g., tilted) substantially vertically to provide a lifting thrust. FIG. 1B illustrates the tiltrotor aircraft 100 in an airplane mode, in which proprotors 114 and 116 are positioned substantially horizontally to provide a forward thrust, in which a lifting force is supplied by wing 108. It should be appreciated that tiltrotor aircraft can be operated such that proprotors 114 and 116 are selectively positioned between airplane mode and helicopter mode, which can be referred to as a conversion mode.

In some embodiments of the present disclosure, locating the sprag clutch 141 in a fixed part of the left rotor system 110 and the sprag clutch 143 in a fixed part of the right rotor system 112, rather than in a part that changes orientation such as the proprotors 114/116, allows for improved operation of the sprag clutches 141/143. By locating the sprag clutches 141/143 in fixed parts of the rotor systems 110/112, lubricant (e.g., oil) within the sprag clutches 141/143 is retained during all operations of the tiltrotor aircraft 100, including when grounded, in helicopter mode, in airplane mode, and in all modes in-between. A sprag clutch located in a proprotor, for example, may have its lubricant drain into less efficient locations within the sprag clutch when the proprotor is tilted in a vertical orientation. Thus, utilization of the sprag clutches described herein within fixed parts of the rotor systems allows for efficient and reliable lubrication of the sprag clutches in all orientations and operations.

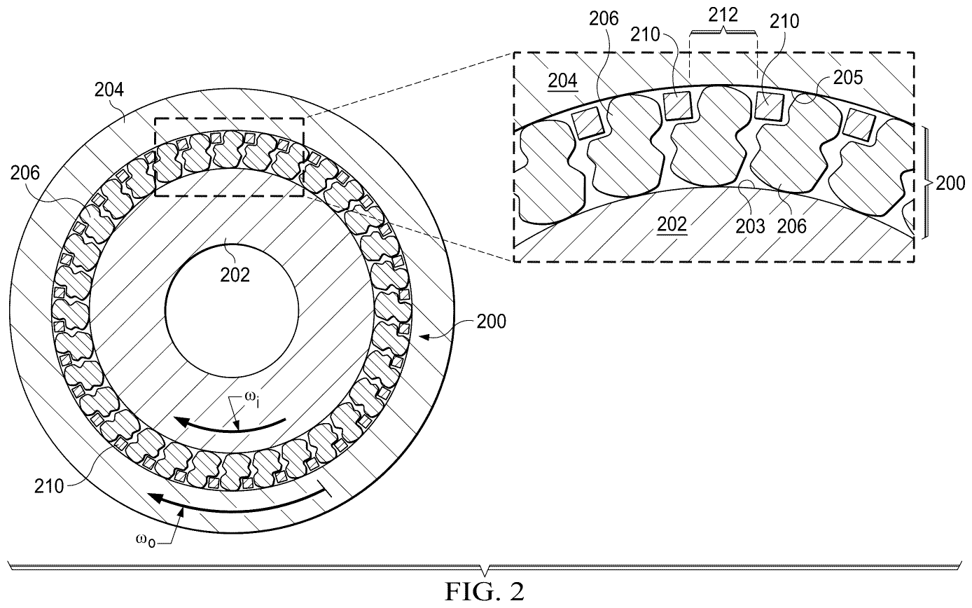

Turning to FIG. 2, a cross-sectional schematic of a sprag clutch 200 is shown, in accordance with some embodiments. A magnified portion of the sprag clutch 200 is also shown. The sprag clutch 200 is disposed between an inner race 202 and an outer race 204, which are rotatable components that may be mechanically coupled by the sprag clutch 200 under certain conditions, described in greater detail below. The inner race 202 and the outer race 204 may be independently attached to other rotatable components such as shafts, gears, couplings, or the like. The inner race 202 and the outer race 204 may transmit torque to and/or receive torque from the rotatable components. The inner race 202 may also be called an “inner race” or “inner raceway” and the outer race 204 may also be called an “outer race” or “outer raceway.”

The sprag clutch 200 shown in FIG. 2 comprises multiple sprags 206 disposed between the inner race 202 and the outer race 204, and a retainer 210 that holds the sprags 206. The retainer 210 comprises multiple sprag windows 212, which are openings in the retainer 210 through which the sprags 206 may protrude to contact the outer race 204. Each sprag 206 has a corresponding sprag window 212 in the retainer 210. The sprags 206 allow the outer race 204 to rotate relative to the inner race 202 in one direction but not the opposite direction. For example, when the rotational speed wi of the inner race 202 is equal to (or less than) the rotational speed Wo of the outer race 204, the sprags 206 engage with the inner surface 203 of the inner race 202 and the inner surface 205 of the outer race 204. which allows torque to be transferred from the outer race 204 to the inner race 202. In other words, the sprag clutch 200 transmits power from the outer race 204 to the inner race 202 by wedging the sprags 206 between the races 202/204. In this manner, the inner race 202 and the outer race 204 may be driven at the same rotational speed. When the rotational speed ωₒ of the outer race 204 is less than the rotational speed wi of the inner race 202, the sprags 206 disengage with the inner surface 203 of the inner race 202 and allow the inner race 202 to independently rotate (e.g., “overrun” or “freewheel”) with respect to the outer race 204. In some embodiments, the sprag clutches described herein allow for “standard” and/or unmodified sprags to be used without negatively impacting reliability or lifetime. The sprag clutch 200 in FIG. 2 is an example shown for illustrative purposes, and other configurations of sprag clutches, overrunning clutches, or the like are possible and considered within the scope of the present disclosure.

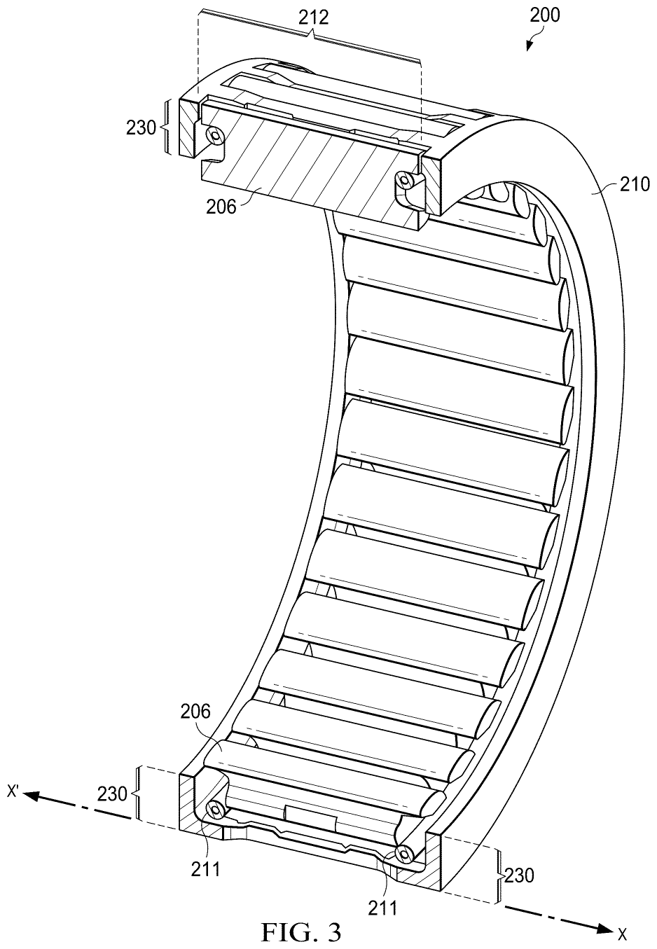

FIG. 3 illustrates a view of a portion of a sprag clutch 200, in accordance with some embodiments. Portions of the sprag clutch 200 are not shown in FIG. 3, so that a cross-section of the sprag clutch 200 is visible. The sprag clutch 200 shown in FIG. 3 is similar to the sprag clutch 200 shown in FIG. 2. For example, the sprag clutch 200 shown in FIG. 3 comprises a plurality of sprags 206 held by a retainer 210. The retainer 210 comprises sprag windows 212 corresponding to the sprags 206. The retainer 210 also comprises a rim 230 on either side of the retainer 210, which are ring-shaped portions that help secure the sprags 206 and also provide additional structural support and rigidity for the retainer 210. The sidewalls of the rims 230 may be annular or circular. The sprag clutch 200 of FIG. 3 also includes energizing springs 211, which may not be present in other embodiments.

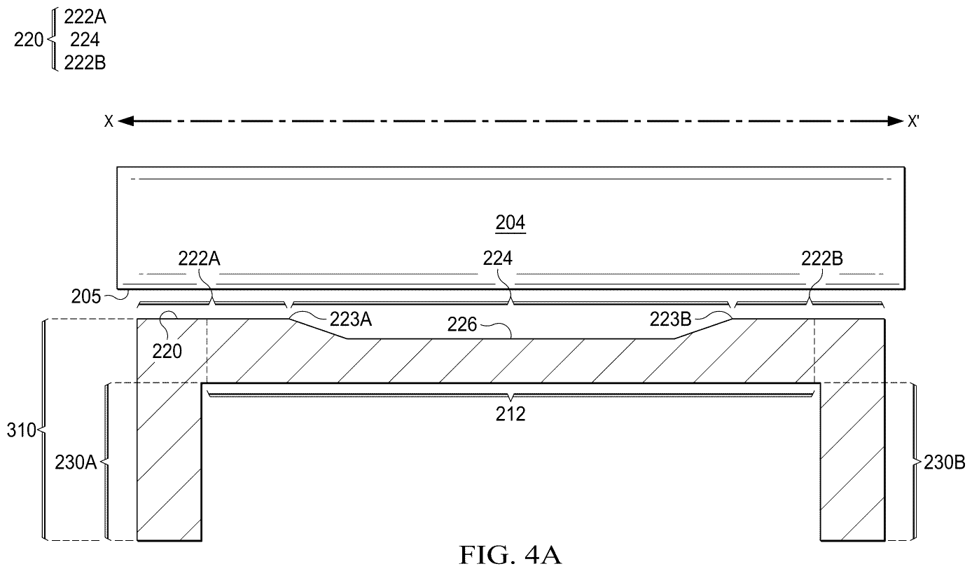

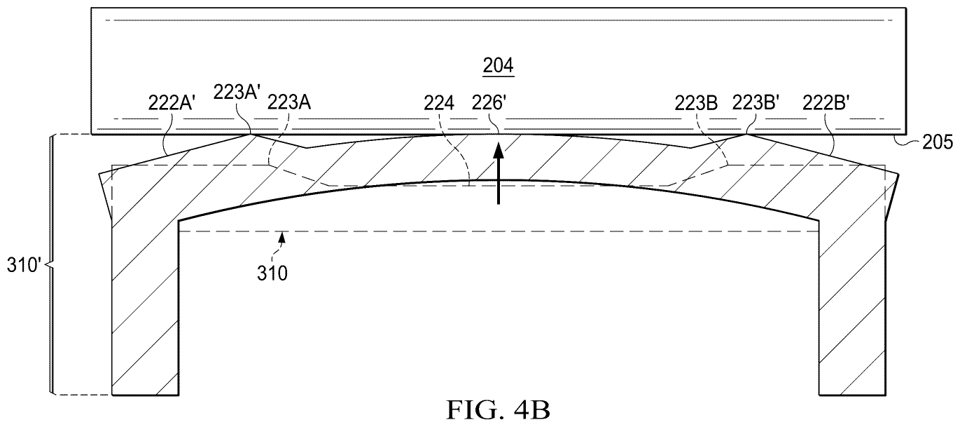

In some cases, during operation, high centrifugal force loads can cause radial deflection of the retainer 210, which can result in the retainer 210 contacting the inner surface 205 of the outer race 204. This can result in failure, unsafe conditions, or accelerated wear of the sprag clutch and/or the outer race. As an illustrative example, FIGS. 4A and 4B illustrate a cross-sectional view of a portion of a retainer 310 of a sprag clutch. FIG. 4A illustrates the retainer 310 when the sprag clutch has relatively small (or no) rotational speed, and FIG. 4B illustrates the retainer 310 when the sprag clutch has a relatively high rotational speed. As described below, the retainer 310 may deform at relatively high rotational speeds. For clarity, the sprags are not illustrated, and only a portion of the retainer 310 is shown. The cross-sectional view of the retainer 310 shown in FIGS. 4A-4B may be along a cross-section X-X′ that is similar to the cross-section X-X′ of the retainer 210 indicated in FIG. 3.

The retainer 310 may be part of a sprag clutch similar to the sprag clutch 200 shown in FIG. 3, in some cases. For example, the retainer 310 includes rims 230A-B on opposite sides of the retainer 310. The rims 230A-B are at opposite ends of the retainer 310 along the axis of rotation. The retainer 310 also includes sprag windows 212, which are not visible in the view of cross-section X-X′, but the approximate location of an adjacent sprag window 212 is indicated in FIG. 4A. With reference to FIG. 4A, the retainer 310 includes an outer face 220, which is the surface of the outer portion of the retainer 310 that faces the outer race 204. The outer face 220 extends from one side of the retainer 310 to the opposite side of the retainer 310. The outer face 220 is a surface of the outer portion of the retainer 310 that extends from the rim 230A to the rim 230B. In some cases, the region of the outer face 220 aligned over (e.g. axially overlaps) a rim 230 may be considered to be an outer surface of that rim 230. The sprag windows 212 are openings in the outer portion of the retainer 310, and are thus also openings in the outer face 220 of the retainer 310. The rims 230A-B extends substantially in a radial direction, and the outer portion (and the outer face 220) of the retainer 310 extends substantially in an axial direction. In this manner, the outer portion of the retainer 310 (and the outer face 220) may have a generally cylindrical shape.

In some cases, the outer face 220 includes a recessed surface 224 that extends between two pilot surfaces 222A-B. The pilot surfaces 222A-B and the recessed surface 224 are contiguous, and collectively define the continuous surface that forms the outer face 220. The pilot surfaces 222A-B are located at or near opposite sides of the retainer 310. The pilot surfaces 222A-B may be surfaces that are approximately parallel to the inner surface 205 (e.g. at zero rotation) in a cross-sectional view, and allow for proper seating of the sprag clutch and smooth rotation of the sprag clutch. Accordingly, the pilot surfaces 222A-B are cylindrical or approximately cylindrical. The pilot surfaces 222A-B are encircled by the inner surface 205 and may be approximately concentric to the inner surface 205, though some shifting or offset may be present. As shown in FIG. 4A, the pilot surfaces 222A-B may be located over the rims 230A-B (e.g., may be axially overlapping the rims 230A-B) and may extend toward the middle of the outer face 220. The recessed surface 224 is a surface that is recessed from the pilot surfaces 222A-B. For example, the recessed surface 224 may be farther from the inner surface 205 than the pilot surfaces 222A-B. In some cases, a central region 226 of the recessed surface 224 may be parallel to the pilot surfaces 222A-B. The edge shared by the pilot surface 222A and the recessed surface 224 is indicated by the pilot edge 223A, and the edge shared by the pilot surface 222B and the recessed surface 224 is indicated by the pilot edge 223B. At the pilot edges 223A-B, the slope of the outer face 220 changes. For example, one side of the pilot edge 223A is the pilot surface 222A portion of the outer face 220, and the other side of the pilot edge 223A is the recessed surface 224 portion of the outer face 220. In this manner, the pilot surface 222A may extend from an adjacent sidewall of the retainer 310 to the pilot edge 223A. The pilot surface 222A and the adjacent sidewall may share an edge, which has a circular shape. The pilot surface 222B and the pilot edge 223B may have a similar configuration.

FIG. 4B illustrates the retainer 310 during relatively high rotational speed, causing the retainer 310 to deflect toward the outer race 204. In FIG. 4B, the retainer as it deflects under high rotational speed is indicated as retainer 310′to distinguish from the “un-deflected” retainer 310, an outline of which is also shown for comparison. In some cases, a retainer tends to deflect most at regions away from the rims 230, such as the regions along the sprag windows 212. This is shown in FIG. 4B, with the pilot surfaces 222A′-B′ and the central region 226′ of the recessed surface 224 being deflected toward the outer race 204. In some cases, the deflection may be significant enough that pilot edges 223A′-B′ of the outer face 220 contact the inner surface 205 of the outer race 204. This is shown in FIG. 4B, with the pilot edges 223A′-B′ contacting the inner surface 205 due to deflection. In some cases, the deflected central region 226′ may also contact the inner surface 205, as shown in FIG. 4B. In other cases, only one or both of the pilot edges 223A′-B′ contact the inner surface 205. As stated previously, contact between a retainer and the outer race can lead to unsafe operation or increased wear. In some cases, the sides of a retainer can deflect (e.g., bow or bend) outward near the outer face 220, as shown in FIG. 4B.

FIGS. 5A and 5B illustrate a cross-sectional view of a portion of a retainer 210 of a sprag clutch, in accordance with some embodiments. The retainer 210 may be similar to the retainers 210 shown in FIG. 2 or FIG. 3, and may be part of a sprag clutch similar to the sprag clutch 200. The retainer 210 is similar to the retainer 310 described for FIGS. 4A-4B, except that the outer face 220 of the retainer 210 has been contoured to reduce contact between the retainer 210 and the outer race 204 due to deflection at relatively high rotational speeds.

FIG. 5A illustrates the retainer 210 when the sprag clutch has relatively small (or no) rotational speed. FIG. 5B illustrates the retainer 210 as it deflects under high rotational speed. The deflected retainer is indicated as retainer 210′, and the un-deflected retainer is indicated as retainer 210, an outline of which is shown for comparison. The deflection of the retainer 210′ shown in FIG. 5B is illustrative, and a retainer 210 may be deflected differently in other cases. For clarity, the sprags are not illustrated in FIGS. 5A-5B, and only a portion of the retainer 210 is shown. The cross-sectional view of the retainer 210 shown in FIGS. 5A-5B may be along a cross-section X-X′ that is similar to the cross-section X-X′ of the retainer 210 indicated in FIG. 3 and that is similar to the cross-section X-X′ of the retainer 310 shown in FIGS. 4A-4B.

Referring to FIG. 5A, the outer face 220 of the retainer 210 includes a pilot surface 222A and a pilot surface 222B at opposite ends of the outer face 220, with a recessed surface 224 extending from the pilot surface 222A to the pilot surface 222B. The recessed surface 224 transitions to the pilot surfaces 222A-B at the pilot edges 223A-B. In some embodiments, the recessed surface 224 comprises sloped side regions 225A-B at or near the pilot edges 223A-B, with a central region 226 having a substantially flat surface that is approximately parallel to the pilot surfaces 222A-B. The retainer 210 is example, and outer faces 220 having other dimensions, shapes, slopes, surfaces, contours, or profiles may be formed in other embodiments.

The retainer 210 is similar to the retainer 310, except that the locations of the pilot edges 223A-B are formed closer to the sidewalls of the retainer 210. For example, in some embodiments, the pilot surfaces 222A-B may not extend beyond the rims 230A-B. Because the rims 230A-B provide rigidity, portions of the retainer 210 near the rims 230A-B deflect less than portions of the retainer 210 near the sprag windows 212. Thus, forming the retainer 210 such that the pilot edges 223A-B are closer to the rims 230A-B can reduce deflection of the pilot edges 223A-B. For example, as shown in FIG. 5B, the deflected pilot edges 233A′-B′ are not deflected outward enough to contact the inner surface 205 of the outer race 204, due to the pilot edges 233A-B being relatively close to the rims 230A-B. The central portion 226′ of the recessed surface 224 is also shown as not having enough deflection to contact the inner surface 205. In some cases, the outward deflection of the pilot edges 223A′ and 223B′ may be less than the outward deflection of the central portion 226′, as shown in FIG. 5B. The particular dimensions of the pilot surfaces 222A-B and/or the particular contour of the recessed surface 224 may be configured to avoid contact between the retainer 210 and the outer race 204, depending on the particular application or operating conditions of the sprag clutch 200. Some non-limiting examples of embodiment retainers 210 are described below. In this manner, the techniques described herein allow for clearance to be maintained between the retainer of a sprag clutch and the outer race under all operating conditions, allowing for improved operation, safer operation, improved reliability, and longer part lifespan.

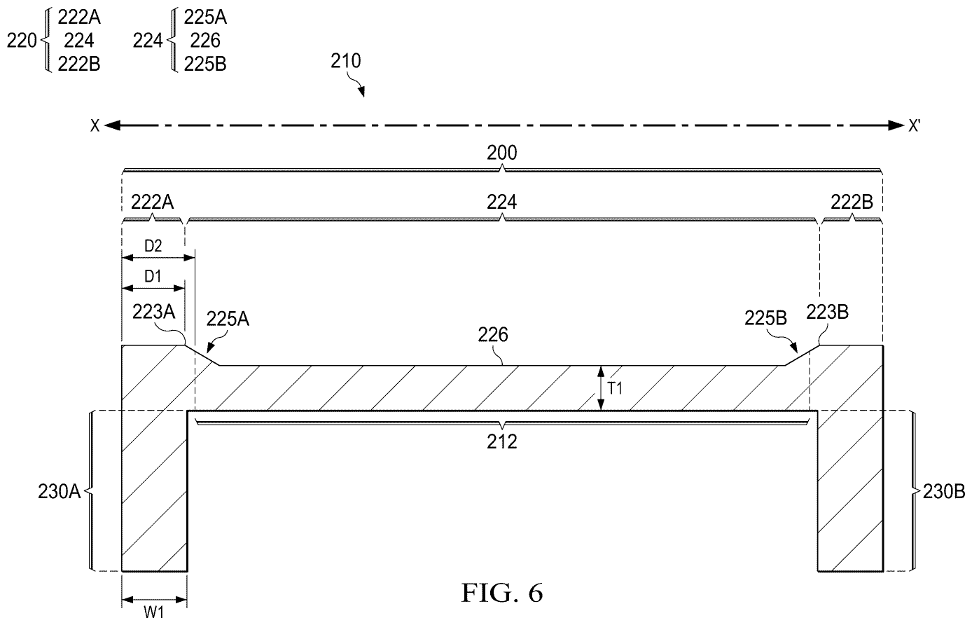

FIG. 6 illustrates a cross-sectional view of the retainer 210 shown in FIG. 5A, in accordance with some embodiments. As described previously, the outer face 220 of the retainer 210 is contoured to avoid contact with the outer race 204 for all rotational speeds. The outer face 220 has a first pilot surface 222A at one side of the retainer 210, a second pilot surface 222B at the opposite side of the retainer 210, and a recessed surface 224 extending from the first pilot surface 222A to the second pilot surface 222B. The pilot edges 223A-B designate the boundaries between the recessed surface 224 and the pilot surfaces 222A-B. As shown in FIG. 6, the pilot edges 223A-B are located a distance D1 from the sidewalls of the retainer 210, and the sprag windows 212 are located a distance D2 from the sidewalls of the retainer 210. Accordingly, the width of the pilot surfaces 222A-B is also the distance D1. The rims 230A-B are shown having a width W1, but in some cases the rims 230A-B may have multiple widths. The width W1 may also be considered a thickness in the axial direction, in some cases.

As described previously, locating the pilot edges 223A-B closer to the sides of the retainer 210 can reduce the risk that the pilot edges 223A-B may contact the outer race 204 when deflected. For example, locating the pilot edges 223A-B near the rims 230A-B can reduce deflection due to the rigidity of the rims 230A-B. Accordingly, a smaller distance D1 can allow for reduced contact between the retainer 210 and the outer race 204. A smaller D1 corresponds to narrow pilot surfaces 222A-B, and thus reducing the width D1 of the pilot surfaces 222A-B can allow for reduced contact between the retainer 210 and the outer race 204. In some embodiments, the pilot surfaces 222A-B are not completely eliminated (e.g., D1 is nonzero), so that the pilot surfaces 222A-B are still able to facilitate proper positioning and centering of the retainer 210. In some embodiments, the distance D1 may be approximately the same as the width W1, such that the width of the pilot surfaces 222A-B is approximately the same as the width of the rims 230A-B. In other embodiments, the distance D1 may be less than W1 or greater than W1. In some embodiments, the distance D1 is less than the distance D2, such that the pilot edges 223A-B are closer to the sides of the retainer 210 than the sprag windows 212. In such embodiments, the pilot surfaces 222A-B are closer to the sides of the retainer 210 than the sprag windows 212. In other embodiments, the distance D1 may be about the same as D2 or greater than D2.

In the embodiment shown in FIG. 6, the recessed surface 224 of the retainer 210 includes a first side region 225A adjacent the first pilot surface 222A, a second side region 225B adjacent the second pilot surface 222B, and a central region 226 extending from the first side region 225A to the second side region 225B. In some embodiments, the side regions 225A-B have sloped surfaces and the central region 226 has a flat surface that is parallel to the pilot surfaces 222A-B. The slope or the width of the side regions 225A-B may be chosen according to the particular application or operating condition, in some cases. For example, side regions 225A-B that are wider or have a shallower slope may allow for improved rigidity, and side regions 225A-B that are narrower or have a steeper slope may allow for reduced risk of contact between the retainer 210 and the outer race 204. In other embodiments, the side regions 225A-B have another slope, shape, or surface profile than shown. In some embodiments, the side regions 225A-B may overlap the inner sides of the rims 230A-B and/or the outer sides of the sprag windows 212. The central region 226 may have a width that is greater than, about the same as, or smaller than a width of the sprag windows 212. In some embodiments, along the outer face 220, the retainer 210 has a smallest thickness T1 along the central region 226. In other words, the largest offset between the pilot surfaces 223A-B and the recessed surface 224 may be along the central region 226.

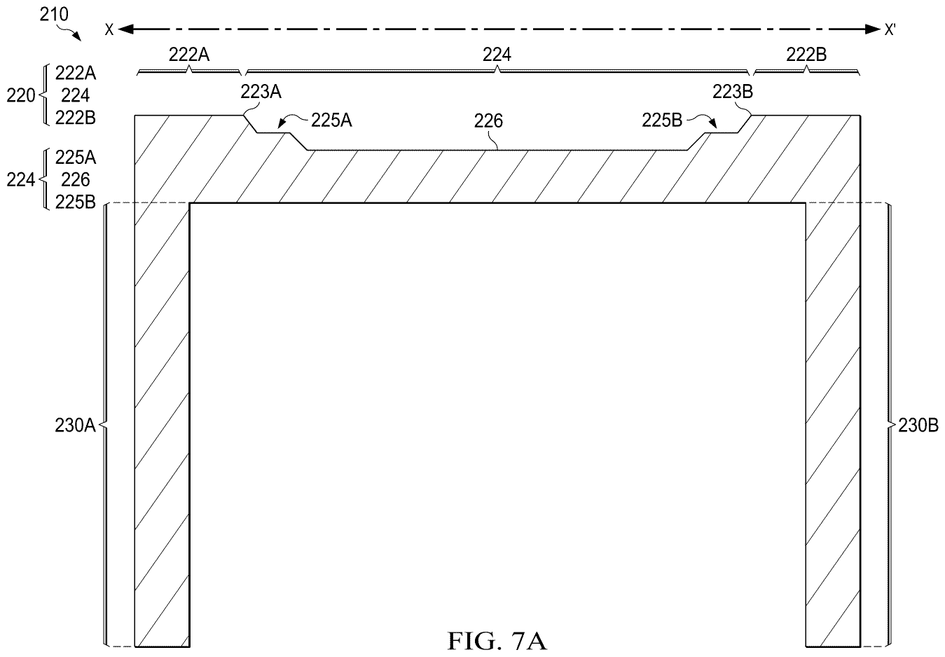

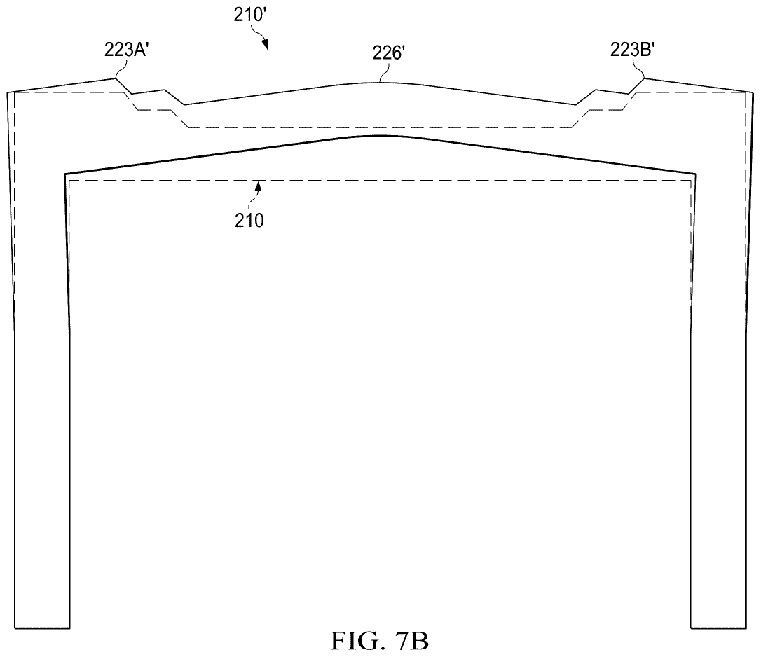

FIGS. 7A and 7B illustrate a cross-sectional view of a portion of a retainer 210 of a sprag clutch, in accordance with some embodiments. The retainer 210 of FIGS. 7A-7B may be similar to the retainer 210 of FIGS. 5A-5B except that the side regions 225A-B have a surface profile comprising both slopes and steps instead of a single sloped surface. FIG. 7A illustrates the retainer 210 when the sprag clutch has relatively small (or no) rotational speed. FIG. 7B illustrates the retainer 210 as it deflects under high rotational speed. The deflected retainer is indicated as retainer 210′, and the un-deflected retainer is indicated as retainer 210, an outline of which is shown for comparison. The deflection of the retainer 210′shown in FIG. 7B is illustrative, and a retainer 210 may be deflected differently in other cases. For clarity, the sprags are not illustrated in FIGS. 7A-7B, and only a portion of the retainer 210 is shown. The cross-sectional view of the retainer 210 shown in FIGS. 7A-7B may be along a cross-section X-X′ that is similar to the cross-section X-X′ of the retainer 210 indicated in FIG. 3.

As shown in FIGS. 7A-7B, contouring the side regions 225A-B to have steps can reduce the distance that the pilot edges 223A-B extend toward the outer race 204 when deflected. Having a stepped profile can effectively bring the pilot edges 223A-B closer to the sides of the retainer 210 while still providing rigidity to the retainer 210 near the pilot surfaces 222A-B. In this manner, deflection of the retainer 210 can be reduced and contact between the retainer 210 and the outer race 204 can be reduced. The side regions 225A-B may have a different number of steps than shown, and the surfaces between the steps may be sloped (as shown in FIGS. 7A-7B), vertical, or curved.

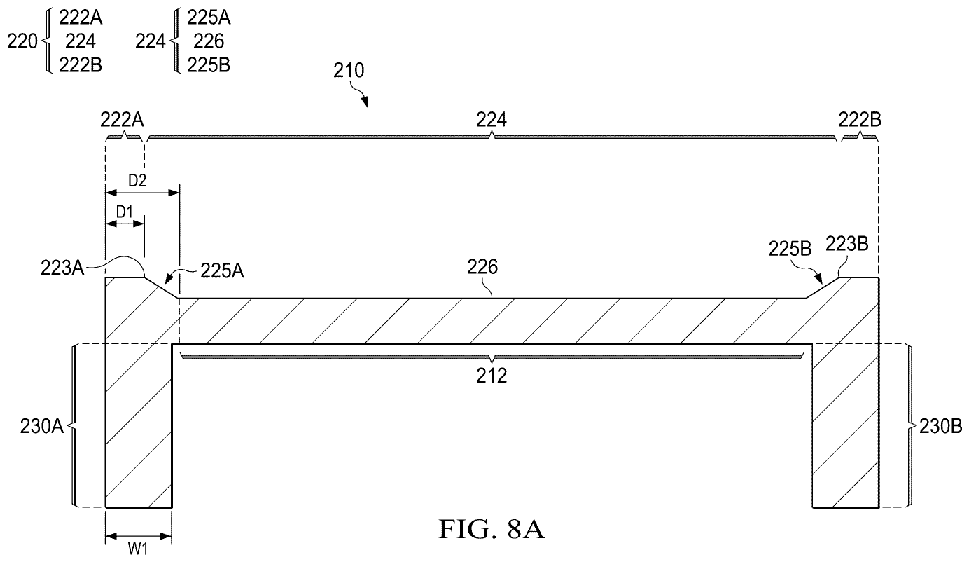

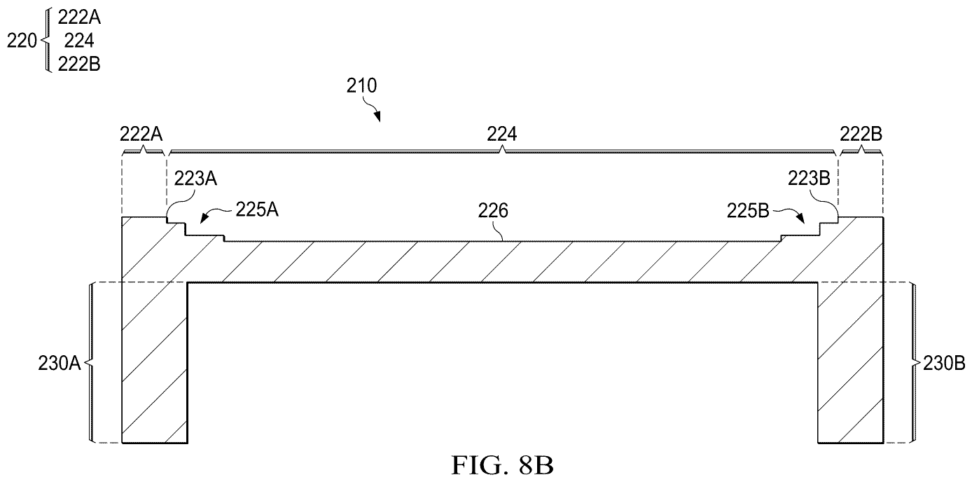

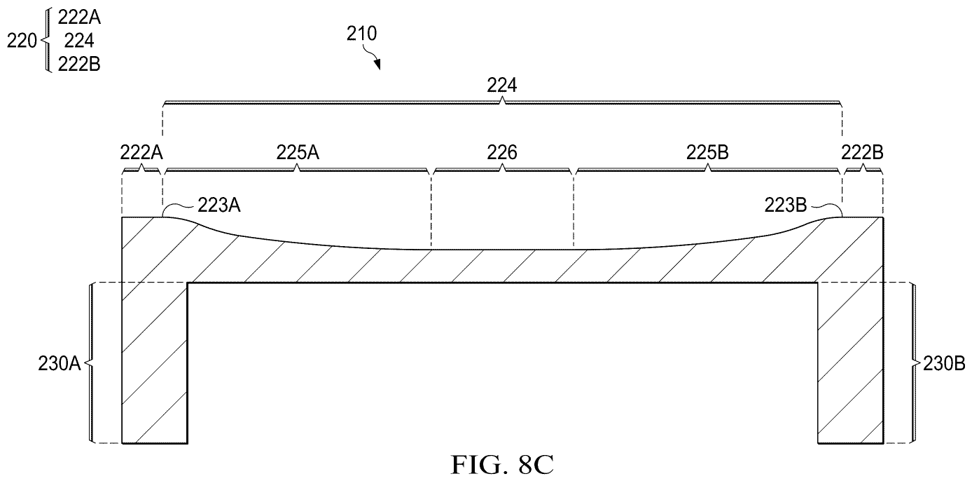

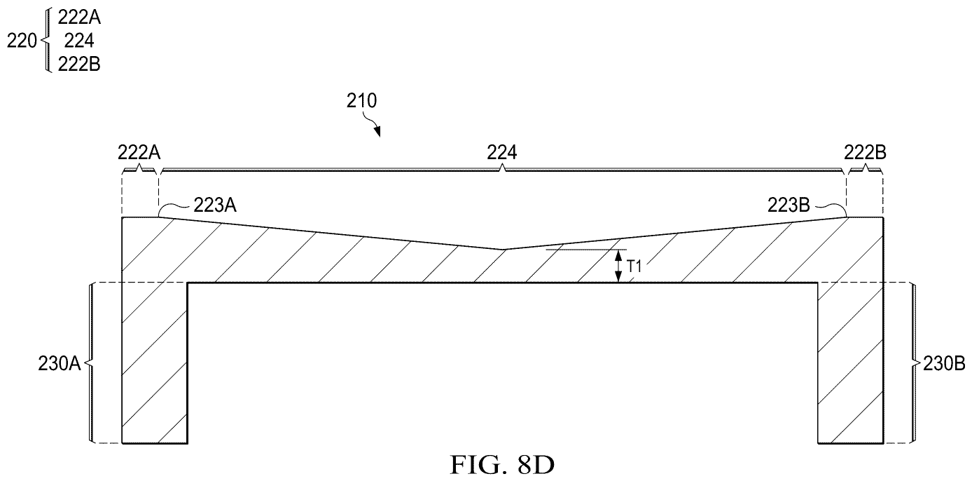

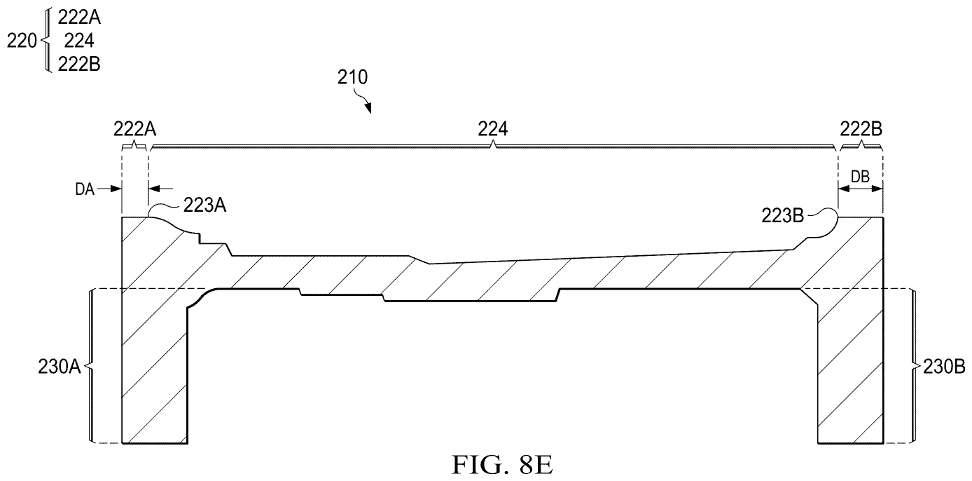

FIGS. 8A through 8E illustrate example retainers 210 with contoured outer faces 220, in accordance with some embodiments. The retainers 210 in FIGS. 8A-8E are similar to the retainers 210 described previously for FIGS. 5A, 6, and 7A, except that the outer faces 220 have different contoured surfaces that can reduce contact between the retainer 210 and the outer race 204. The retainers 210 in FIGS. 8A-8E are intended as a non-limiting set of illustrative examples, and other retainers having other dimensions, other outer faces, or other configurations are possible. Additionally, the various different surfaces or characteristics of the retainers 210 described herein may be combined in any suitable combination or arrangement.

FIG. 8A illustrates a retainer 210 similar to the retainer 210 shown in FIG. 6, except that the distance D1 of the pilot edges 223A-B is less than the width W1 of the rims 230A-B. Because the distance D1 is less than the width W1, the pilot surfaces 222A-B have a smaller width than the rims 230A-B. Accordingly, the rims 230A-B laterally overlap the pilot edges 223A-B. Further, the recessed surface 224 partially overlaps (e.g., axially overlaps) the rims 230A-B. In some cases, the side regions 225A-B also at least partially overlap the rims 230A-B. In some cases, the side regions 225A-B do not laterally overlap the sprag windows 212. In other cases, the side regions 225A-B at least partially overlap the sprag windows 212. The side regions 225A-B may have a different slope than shown. For example, in some embodiments, the side regions 225A-B may be approximately vertical surfaces, forming a step between the pilot surfaces 222A-B and the recessed surface 224. An outer face 220 having a smaller distance D1 may have reduced risk of contact to the outer race 204, in some cases.

FIG. 8B illustrates a retainer 210 similar to the retainer 210 shown in FIG. 6, except that the side regions 225A-B comprise vertical steps. In other embodiments, one or more of the steps may be sloped, similar to the sloped steps of the retainer 210 in FIG. 7A. The side regions 225A-B may have a single step or may have two or more steps. The widths and/or heights of the steps may be configured to reduce contact between the retainer 210 and the outer race 204, in accordance with the particular application or operating conditions of the sprag clutch 200. For example, the steps may be configured such that, when deflected, the outer face 220 is unlikely to contact the outer race 204.

FIG. 8C illustrates a retainer 210 similar to the retainer 210 shown in FIG. 6, except that the side regions 225A-B have curved surfaces. The side regions 225A-B may comprise any suitable curved or contoured surfaces, which may also include planar or piecewise-planar (e.g., faceted) surfaces. In some embodiments, the side regions 225A-B may have a width that is larger than a width of the central region 226, as shown in the example of FIG. 8C. In some embodiments, the entire recessed surface 224 may be a continuous curve without significant planar or flat portions, such that the central portion 226 is small or insignificant. In other words, the recessed surface 224 may be entirely formed of curved surfaces. The particular curvature of the recessed surface 224 may be configured such that, when deflected, the outer face 220 is unlikely to contact the outer race 204.

FIG. 8D illustrates a retainer 210 similar to the retainer 210 shown in FIG. 6, except that the recessed surface 224 is entirely formed of sloped surfaces. For example, the retainer 210 shown in FIG. 8D has a recessed surface 224 that slopes inward from the pilot surfaces 222A-B toward a minimum thickness T1 of the retainer 210. In other embodiments, more sloped regions may be present than shown, and the various sloped regions of the recessed surface 224 may have different slopes. The particular slopes of the recessed surface 224 may be configured such that, when deflected, the outer face 220 is unlikely to contact the outer race 204.

The retainers 210 described for FIGS. 5A through 8D are illustrative examples, and retainers 210 having other outer faces 220 are possible. As another illustrative example, FIG. 8E shows a retainer 210 having an outer face 220 comprising a variety of features and surfaces. For example, in some embodiments, the outer face 220 of the retainer 210 may not be symmetrical (e.g., mirrored across an axis of symmetry). As shown in the retainer 210 of FIG. 8E, the first pilot surface 222A may have a width DA that is different from the width DB of the second pilot surface 222B. The first side region 225A (not labeled in FIG. 8E) may be different from the second side region 225B (not labeled in FIG. 8E). The recessed surface 224 may have a variety of sloped, flat, curved, and stepped surfaces. Additionally, the portion of the retainer 210 along the recessed surface 224 may have a varying thickness. In some embodiments, the width of the rim 230A may be different from the width of the rim 230B. In this manner, the particular contouring of the recessed surface 224 may be configured such that, when deflected, the outer face 220 is unlikely to contact the outer race 204.

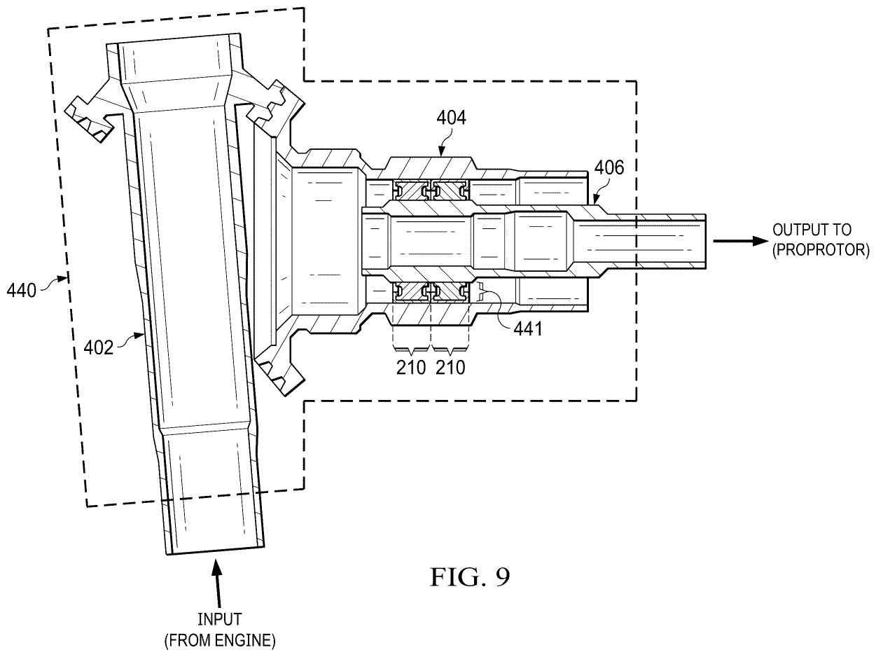

FIG. 9 illustrates a schematic of an example gearbox 440 in accordance with some embodiments. The gearbox 440 shown in FIG. 9 may be similar to the left gearbox 140 or the right gearbox 142 described previously for FIGS. 1A-1B. The gearbox 440 is an illustrative example shown as a spiral bevel gearbox, though other gearboxes, drive systems, or configurations are possible. The gearbox 440 receives power from the engine (e.g., the engine 130 or 132) at the input shaft 402 and transmits that power to an output shaft 406. The output shaft 406 transmits the engine power to, for example, a proprotor (e.g., proprotor 114 or 116) or other components. In the example gearbox 440 of FIG. 9, the input shaft 402 comprises a pinion that engages with a spiral bevel gear 404, and the spiral bevel gear 404 is coupled to the output shaft 406 by a sprag clutch assembly 441. In this manner, the output shaft 406 corresponds to an inner race (e.g., inner race 202) and the spiral bevel gear 404 corresponds to an outer race (e.g., outer race 204). The sprag clutch assembly 441 comprises one or more sprag clutches, which may be similar to the sprag clutches 200 described herein. In some cases, the sprag clutch assembly 441 has two sprag clutches 200, as shown in FIG. 9. In other cases, the sprag clutch assembly 441 has one sprag clutch 200 or more than two sprag clutches 200. The sprag clutches 200 of the sprag clutch assembly 441 may or may not be mechanically coupled by e.g., a spring or the like. In other words, the sprag clutches 200 may or may not be configured to freely rotate relative to each other. In some embodiments, the gearbox 440 is configured such that the rotational speed of the input shaft 402 is greater than the rotational speed of the output shaft 406. Accordingly, since the sprag clutches 200 is coupled to the output shaft 406, the sprag clutches 200 experience smaller speeds than if the sprag clutches 200 were coupled directly to the input shaft 402.

In some cases, coupling the sprag clutches 200 to shaft(s) having slower rotational speed can reduce the risk of reduce the risk of failure and prolong the useable lifetime of the sprag clutch 200. In some cases, a sprag clutch (e.g., sprag clutch 200) in an overrunning state may experience wear (e.g., polishing, pitting, scuffing, or the like) on the inner surface of the inner race or on the sprags. As an example, in some cases, a sprag clutch of a twin engine rotorcraft may be put in an overrunning state during startup if the engine on the opposite side of the rotorcraft has been started first. Wear within the sprag clutch may accumulate over time, and may eventually result in failure of the sprag clutch (e.g., due to “sprag popping” or other failure modes). This wear can be reduced or avoided by reducing the rotational speed experienced by the sprag clutch when in an overrunning state. Thus, situating a sprag clutch in a slower section of the drivetrain can reduce wear during overrunning conditions.

Embodiments described herein can achieve advantages. By forming the outer surface of a sprag clutch retainer to have a contoured profile, contact between the retainer and the outer race can be reduced or avoided during high-speed operation. For example, the techniques described herein can reduce contact between the retainer and the outer race at speeds greater than about 5,000 RPM. For example, in some cases, the sprag clutches described herein can maintain clearance between the retainer and the outer race at speeds of about 10,000 RPM to about 20,000 RPM, though other speeds are possible. By reducing the width of the piloting surfaces, the radial deflection of the outer race at the edges of the pilot surfaces can be reduced. Locating the edges of the pilot surfaces over or near the rims of the retainer can also reduce deflection due to additional stiffness provided by the rims. The techniques described herein can allow for radial clearance between the retainer and the outer race to be maintained in all operational conditions of the rotorcraft and all speeds experienced by the sprag clutch during operation of the rotorcraft. The techniques described herein can also allow contact pressure at clutch surfaces and at outer race surfaces to be reduced, which can reduce wear on these surfaces. In this manner, embodiments described herein can reduce the risk of sprag clutch failure and increase sprag clutch lifetime.

In some embodiments, a sprag clutch includes sprags disposed in a retainer, wherein the retainer includes openings arranged around the retainer, wherein the openings are a first distance from a first annular sidewall of the retainer and are the first distance from a second annular sidewall of the retainer opposite the first annular sidewall; and a first cylindrical surface sharing an edge with the first annular sidewall and extending a second distance from the first annular sidewall, wherein the second distance is less than the first distance; a second cylindrical surface sharing an edge with the second annular sidewall and extending the second distance from the second annular sidewall; and a recessed surface between the first cylindrical surface and the second cylindrical surface. In an embodiment, the second distance is less than an axial thickness of the retainer at the first annular sidewall. In an embodiment, a width of the recessed surface is greater than a width of the openings. In an embodiment, a sloped outer surface of the retainer axially overlaps an edge of an opening. In an embodiment, the first cylindrical surface shares an edge with the recessed surface.

In some embodiments, a rotorcraft includes a first engine; a first gearbox coupled to the first engine, including a spiral bevel gear coupled to a drive shaft of the first engine; and an output shaft coupled to the spiral bevel gear by a sprag clutch, wherein a first retainer of the sprag clutch has an outer surface including a recessed surface, wherein the recessed surface has a stepped profile; and a first proprotor coupled to the output shaft, wherein the first proprotor is operable in a vertical orientation or in a horizontal orientation. In an embodiment, the sprag clutch includes a second retainer, wherein a sidewall of the second retainer contacts a sidewall of the first retainer. In an embodiment, the first retainer and the second retailer are configured to freely rotate about a rotation axis of the sprag clutch with respect to each other. In an embodiment, the first retainer and the second retainer remain separated from the spiral bevel gear during operation of the rotorcraft. In an embodiment, the first retainer includes a rim, wherein the recessed surface axially overlaps the rim. In an embodiment, the outer surface includes a first pilot surface on a first side of the recessed surface and a second pilot surface on a second side of the recessed surface, wherein the first pilot surface and the second pilot surface are parallel. In an embodiment, the steps of the stepped profile are sloped.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A rotorcraft clutch comprising:
an inner race;
an outer race; and
a sprag clutch between the inner race and the outer race, wherein the sprag clutch comprises:
a plurality of sprags; and
a retainer, comprising:
a first rim at a first end of the retainer, wherein the first rim has a first width;
a second rim at a second end of the retainer, wherein the second rim has the first width; and
an outer surface extending axially from the first rim to the second rim, wherein the outer surface faces an inner surface of the outer race, wherein the outer surface comprises a first pilot surface at the first end, a second pilot surface at the second end, and a recessed surface extending from the first pilot surface to the second pilot surface, wherein the recessed surface is farther from the outer race than the first pilot surface, wherein the first pilot surface and the second pilot surface are parallel to the inner surface of the outer race, wherein the first pilot surface extends a second width from the first end, wherein the second pilot surface extends the second width from the second end, wherein the second width is smaller than the first width.

2. (canceled)

3. The rotorcraft clutch of claim 1, wherein a region of the recessed surface has a curved profile.

4. The rotorcraft clutch of claim 1, wherein a region of the recessed surface has a stepped profile.

5. The rotorcraft clutch of claim 1, wherein a region of the recessed surface has a sloped profile.

6. The rotorcraft clutch of claim 1, wherein the recessed surface axially overlaps the first rim and the second rim.

7. The rotorcraft clutch of claim 1, wherein a region of the recessed surface is parallel to the first pilot surface.

8. The rotorcraft clutch of claim 1, wherein the outer surface comprises an opening, wherein the first pilot surface is closer to the first end than the opening.

9. A sprag clutch comprising:
a plurality of sprags disposed in a retainer, wherein the retainer comprises:
a plurality of openings arranged around the retainer, wherein the openings are a first distance from a first annular sidewall of the retainer and are the first distance from a second annular sidewall of the retainer opposite the first annular sidewall;
a first cylindrical surface sharing an edge with the first annular sidewall and extending a second distance from the first annular sidewall, wherein the second distance is less than the first distance;
a second cylindrical surface sharing an edge with the second annular sidewall and extending the second distance from the second annular sidewall; and
a recessed surface between the first cylindrical surface and the second cylindrical surface, wherein the recessed surface is cylindrical, wherein the recessed surface is a third distance from the first annular sidewall, wherein the retainer has a first thickness at the recessed surface, wherein the retainer has a second thickness between the second distance and the third distance from the first annular sidewall, wherein the second thickness is larger than the first thickness.

10. The sprag clutch of claim 9, wherein the second distance is less than an axial thickness of the retainer at the first annular sidewall.

11. The sprag clutch of claim 9, wherein a width of the recessed surface is greater than a width of the plurality of openings.

12. The sprag clutch of claim 9, wherein a sloped outer surface of the retainer axially overlaps edges of the openings of the plurality of openings.

13. The sprag clutch of claim 9, wherein the first cylindrical surface shares an edge with the recessed surface.

14-20. (canceled)

21. A structure comprising:
an inner race;
an outer race;
a first retainer holding a plurality of first sprags, wherein the first retainer separates the outer race from the inner race, wherein an outer surface of the first retainer that faces the outer race comprises a recess, wherein the first retainer comprises a first circular rim, wherein the recess overlaps the first circular rim; and
a second retainer holding a plurality of second sprags, wherein the second retainer is adjacent the first retainer, wherein the second retainer is freely rotatable with respect to the first retainer.

22. (canceled)

23. The structure of claim 21, wherein recess comprises at least one step.

24. The structure of claim 21, wherein a first surface of the recess is sloped and a second surface of the recess is curved.

25. The structure of claim 21, wherein a width of a first sprag of the plurality of first sprags is less than a width of the recess.

26. The structure of claim 21, wherein the outer surface comprises a pilot surface that is parallel to a surface of the outer race, wherein the pilot surface overlaps the first circular rim.

27. The sprag clutch of claim 9, wherein the first cylindrical surface and the second cylindrical surface are parallel.

28. The rotorcraft clutch of claim 8, wherein the first width is smaller than a distance from the first end to the opening.

29. The sprag clutch of claim 9, wherein the first distance is between the second distance and the third distance.
